(19) United States
(12) Patent Application Publication
(10) Pub. No.: US 2018/0015531 A1
(43) Pub. Date: Jan. 18, 2018

(54) System and Method for Complex Objects Molding

(71) Applicant: Sergey Kazantsev, Moscow (RU)

(72) Inventor: Sergey Kazantsev, Moscow (RU)

(21) Appl. No.: 15/649,399

(22) Filed: Jul. 13, 2017

Related U.S. Application Data
(60) Provisional application No. 62/361,912, filed on Jul. 13, 2016.

(51) Int. Cl. B22C 7/02; B29C 33/60; B22C 9/24; B29C 37/00; B29C 39/00; B29C 39/36; B29L 31/00; B29K 21/00

(52) U.S. Cl. CPC B22C 7/02; B29C 39/003; B29C 33/60; B29C 39/36; B22C 9/24; B29C 37/0032; B29K 2021/003; B29L 2031/757

(57) ABSTRACT

A molding system and method, allowing for the repeated use of the same molding insert for purposes of elaborate objects molding is described. The proposed method allows for multiple moldings of intricate shapes and curvatures improving the mass production of the jewelry moldings. During the process, the raw molding material is squeezed through the narrow opening inside the mold form under pressure. As the molding material enters the mold form, it is coated with a coating fluid. After the curing, the molding material could be easily removed through a narrow cavity opening, promptly reassembling back to the shape of the insert for continuous use in the next steps of the molding procedure.

### CROSS-REFERENCE TO RELATED APPLICATIONS

This application is based on and claims benefit to U.S. provisional application 62/361,912 filed on Jun. 13, 2016.

### BACKGROUND OF THE INVENTION

The present invention relates to casting, and more specifically to complex or intricate objects molding for lost-wax casting. Lost-wax casting is also known as investment casting or precision casting, and is largely used by the jewelry manufacturers or any other precision-molding manufacturers.

Particularly, the present invention could be used in molding for casting of complex and intricate hollow objects. Hollow objects casting is gaining wide popularity in the modern world of dwindling precious metal supplies and raising demands for more multifaceted design jewelries. The proposed method allows for multiple time use of the mold which is imperative in mass manufacturing.

### DISCUSSION OF PRIOR ART

Lost-wax casting is very old, dating to 4500 BCE. It is a process by which a duplicate metal master model is cast from the original sculpture. First known objects produced by this method were determined to be 5700 years old. Accordingly, the process is mostly standardized, with some variations being developed from factory to factory.

The name “lost-wax” stems from original use of wax to mold the duplicate of the original master model. Wax was later substituted by other materials like resins, tar, textile or tallow. The complexity of the master model depends totally on skills of the sculptor. Master model could be made on a microscopic scale in jewelry production or on industrial large object scale, where the process became known as investment casting.

The process of lost-wax casting could be broken into the following general steps:
a. Model-making. Artist creates an original sculpture, or master model, from wax, clay, or another soft material, or carve it either by hand-tools or mill by machine from wood, bone, polyurethane, metal or another hard material. Normally, traditional technology is not suitable for production of hollow objects with complicated inner surfaces without cutting the model in parts and combining these parts together at later steps, leading to serious limitations. Majority of art objects with complicated shapes and ornaments cannot be easily divided into parts without damaging the design. The booming development of the 3D printing (rapid prototyping) allowed the manufacturing of complicated objects from various powders, thermal, UV or laser cured resins and some other materials. 3D printing, however, could not be used in mass-manufacturing of intricate objects due to limited materials usage, questionable accuracy, slow rate of printing, and limitations on the size of the product.
b. Moldmaking. A mold (also referred as “mould”) is made of the original master model. The mold is usually made from latex, polyurethane rubber or silicone, and could have have rigid outer mold made from plaster. The mold could usually be reused to make multiple copies of the master model.
c. Waxing. Once the mold is finished, it is filled with molten wax, chilled and opened, to reveal an exact wax replica of the master model. The replica is “chased”, or cleaned by a heated metal object, to remove imperfections. After that the wax copy is “sprued”, or attached to a wax handle that will eventually provide path for the molten metal to flow.
d. Coating. This step could be done in several different fashions. After spruing, the wax copy could be placed in a metal chamber or a flask, suspended by the wax handle, and the chamber is filled with investment, usually a refractory plaster. Investment is allowed to solidify.
e. Burnout. The chamber with solidified investment is placed in a high temperature kiln, allowing the wax to simply burn out, leaving in the solidified investment the negative space or a shell formerly occupied by the wax.
f. Pouring (or casting). The shell is reheated in the kiln, and the melted metal is poured into the shell, allowing it to fill every crevice of the shell. This part of the process could be done in several ways, i.e. gravity pouring, gas pressure pouring, vacuum pouring, or centrifugal pouring. During the pouring, the mold cavity is usually coated with the refractory material or a mold wash, preventing the casting from sticking to the mold and prolonging the mold life. In Gravity pouring, the molten substance is poured into the mold channel on top of the form, allowing gravity to guide the liquefied material to fill every crevice of the form. Gravity pouring works poorly for intricate moldings, as narrow channels and back-pressure prevent molten substance from filling the entire mold cavity. Low-pressure casting uses a gas at low pressure, usually between 20 and 100 kPa to push the molten metal into the mold cavity. Vacuum casting creates a reduced pressure inside the mold, prior to pouring the molten substance. In centrifugal casting, a permanent mold is rotated continuously about its axis at high speeds (300 to 3000 rpm) as the molten metal is poured. The molten metal is centrifugally thrown towards the inside mold wall, where it solidifies after cooling.
g. Release. The shell is cooled and hammered to release a metal replica of the master model, which is then cleaned and polished to achieve a perfect replica of the original master model.

Jewelry and small parts are usually made with slightly different process. A wax model is prepared by either carving or from hot wax injection into a mold. The wax is sprued and fused onto a rubber base, called a “sprue base”. Then a metal cylinder is put over the sprue base and the wax model. Refractory plaster investment is mixed and poured in to fill the flask. As it hardens, it is burned out, and the metal is poured into the formed empty cavity, followed by the product removal and cleaning.

The mold is generally prepared by the process known as molding (or moulding), when liquid or pliable raw material is shaped and solidified using a rigid frame called a mold or matrix. A mold is usually made in a hollowed-out block that is filled with a liquid or pliable material like plastic, glass, metal, rubber, or ceramic raw materials, placed around a model. The liquid hardens or sets inside the mold, adopting the shape of the container and of the model inside the mold. A mold is the counterpart of a cast. Bi-valve molding is one of the most common, using two molds, one for each half of the object. Larger and more valuable objects are made by a process known as piece-molding, when a number of different molds is combined, each creating a section of a complicated object.

Jewelry makers usually utilize the process known as rubber molding. The model is pressed into natural soft rubber, or related polymer (hereinafter referred as “rubber”), so it is surrounded completely. The rubber or polymer is then vulcanized. Vulcanization is a process of converting natural rubber or related polymers into more durable materials via subjecting the raw material to a higher temperature or via the addition of vulcanizing agents like sulfur or other equivalent curatives or accelerators. These additives modify the polymer by forming cross-links (bridges) between individual polymer chains. Vulcanized materials are less sticky and have superior mechanical properties. Upon hardening, the rubber mass is dissected with a knife into two halves, or more parts for complicated structures, to remove the model, leaving an empty cavity for waxing.

The lost-wax casting of solid objects is generally straightforward. More complex forms are casted with the use of multiple sprues. Generally, sprues are the hollow shafts for liquid reaching the inside cavity of the mold. The wax copy is sprued with a treelike structure, having a stem and sprues connected to wax replicas. After burning the wax sprues form paths for the molten metal to flow and for air to escape. Spruing is usually carefully planned. It begins at the top with a wax “cup”, which is attached by wax cylinders to various points on the wax copy. The spruing is melted out later in the process, leaving hollow channels for the casting material to flow.

Spruing planning becomes particularly important in a mass production of jewelry. To make exact replica of a ring over and over again would be a very laborious and tedious task. Instead, a large number of wax replicas is prepared and sprued on a larger wax stem, resembling a tree with large number of branches. The entire tree is than placed in a casting cylinder, filled with investment, burned out and casted with a molten material, allowing to produce large quantities of the same object.

The process becomes more complicated when a hollow or partially hollow article needs to be made. Hollow jewelry pieces are often desired for aesthetic appearance. Additionally, having a hollow object significantly reduces weight and price, especially if precious metals are used for casting. While casting the hollow object is generally done by using the above-described process, the mass production of hollow jewelry articles is very challenging and time-consuming process, leading to increased prices of the produced items.

Usually, the hollow metal object is cast from a hollow wax replica. One of the ways the hollow wax replica is prepared is by producing two molds. The first (outer) mold has an inner cavity shaped in accordance with the external shape of the desired item. The second mold has an inner cavity formed in the shape slightly smaller than the external shape of the desired item. The second mold is used to produce an insert. The insert is usually made from the same material as an outer first mold, usually from rubber or rubber-like polymer material. The insert is then placed in the cavity of the first outer mold and is maintained in a precise, predetermined position by the spacer pins. Molten wax is introduced into the space between the insert and outer mold, filling the cavity inside, completely surrounding the insert. The wax hardens, and is removed from the first (outer) mold cavity. The insert is then removed from the wax article by different methods, leaving a hollow solid wax article, which is used in the casting of the desired metal article.

If the insert has a cylindrical shape, the insert molding and removal is relatively easy and straightforward. If the desired article gets more curvature, or has a very narrow entryway, the placement of the molding material and following removal of the insert from the hardened wax replica gets very tricky and complicated.

The rubber insertion into the mold is usually done by a simple compression of the raw rubber through the mold opening, usually by utilizing a narrow object to push rubber particles inside. There is always a challenge of evenly spreading the raw material into the cavity, avoiding any bubbles or empty crevices, which would result in the defective insert. After the mold is filled with the raw material, it is vulcanized, leading to solidification of the rubber inside the mold, making the insert ready for removal.

The insert removal from any narrow cavity entrance of the mold is usually done by chemical, water soluble or mechanical means. Any of those means generally lead to the destruction and waste of the insert. Even if the insert is artfully and very slowly sliced and removed piece by piece, the reuse of such disintegrated insert is very complicated and short-lived. As a result, the next hollow wax model requires an added preparation step of the new insert. Additionally, the process of the insert removal by dissolving in water or other chemical is difficult to control and to manage to completion. Generally, some traces of the insert material are left inside the hollow area leading to deformities and to the increased weight of the product, dramatically affecting the price of any produced final piece, unacceptable in the jewelry production. For mass production of hollow jewelry or very intricate items, the repeated slow removal, discard, and re-creation of inserts is a time-limiting and material-wasting step. When the production targets thousands of hollow identical objects per day, the cost of the slowdown and the material waste could become astonishing.

Thus, there is a clearly felt need for a new system and method of the insert molding which will allow for easy placement of the raw material, followed by convenient removal of the insert without impairment, so it could be reused for the creation of another model. Recycling of the insert will lead to improved capacities, significant lowering of the cost, and waste reduction.

The disclosed invention addresses these and some other issues related to the current state of molding technology.

### SUMMARY OF THE INVENTION

Accordingly, the primary objective of the present invention is to provide a new and improved method of molding for lost-wax casting.

According to the present invention, the raw molding material could be any elastomer that could be converted into a more durable and rigid material by means of outside influence, a process sometimes referred as curing or vunlcanization. Elastomers are natural or synthetic polymers having elastic properties. For instance, a high temperature vulcanizing silicone (HTV) mold making rubber, room temperature vulcanization (RTV) silicone putty, thermoplastic rubbers (also known as thermoplastic elastomers, or TPE), reactoplastic polymers, or others with similar polymerization properties could be used. Thermoplastic elastomers are usually any rubber-like polymers, that could be solidified by a process of vulcanization using additives and higher temperature. Reactoplastics are polymers that could be vulcanized by chemical processes. The raw molding material should be soft enough to come out of a squeezable container through a narrow opening. The narrow opening of the squeezable container should fit the opening of the mold for the insert. For purposes of this invention, the insert is the inner part of the hollow object molding. During the molding of the hollow object, the insert is placed in a larger mold, and is maintained in a precise, predetermined position by the spacer pins.

Upon application of the pressure on the squeezable container, the molding material starts protruding out through the narrow opening in a shape of a narrow cylindrical thread or line. If the narrow opening is lined up with the opening of the insert mold, the narrow thread of the molding material fills the mold of the insert. The vacant cavity of the insert, prior to being filled with the raw molding material, can be filled with a coating fluid, or coating mix, so the narrow cylindrical thread gets coated evenly by said fluid upon the entry into the mold cavity. The cavity of the insert gets tightly packed by the raw molding narrow cylindrical thread similar to bowl being filled with the uninterrupted and continuous spaghetti. Like spaghetti being coated with the olive oil, the continuous cylindrical thread of the molding material gets coated with the coating fluid. To avoid air-bubbles, the molding material inside the mold could be pressed with a narrow tool, assuring the tight and compact packaging.

In alternative to prefilling the insert cavity with a coating fluid, the process of the molding material thread coating could be achieved by co-extrusion. Co-extrusion is the process of pressing the molding material thread and the coating fluid through the same container opening, allowing the thread to be coated with fluid prior to entering the insert cavity.

The coating fluid or coating mix could be selected from number of liquids like mineral oils, organic oils, siloxanes, or other known Mold Release liquids. In general, oil is any neutral, nonpolar chemical substance that is a viscous liquid at ambient temperatures and is both hydrophobic and lipophilic. Organic oils have high carbon and hydrogen content, and could be either produced by plants, animals, and other organisms. Mineral oils are usually referred to oils generated from fossilized origins, and are usually produced from crude oil, or petroleum. Both organic and mineral oils could be produced or modified through synthesis. Siloxanes, or silicone oils, are the oligomeric and polymeric hydrides that have a Si—O—Si linkage (siloxane) and a general formulae H(OSiH₂)ₙOH and (OSiH₂)ₙ. Mold release liquids are usually referred to chemicals that are used to prevent other materials from bonding to surfaces.

The coating fluid could be a combination of different liquids or solids. Solids are usually powders selected from but not limited to metal powders, metal oxide powders, silicate or magnesium origins powders, calcium carbonate, granite powder, or numerous synthetic powder fillers currently used in the industry. The main characteristic of the coating fluid is its inertness to the molding material and to curing conditions. The coating fluid covers the continuous cylindrical thread of the molding material, preventing it from sticking and binding together, and allowing for an uninterrupted and smooth float of the molding material from the container into the insert mold cavity, until the entire capacity of the insert mold cavity is tightly filled with the molding material.

Upon adequate pressure application from the squeezable container, the cylindrical thread of the molding material fills every nook and crevice of the desired mold. The end of the thread is cut outside of the mold entry, allowing enough of the thread to stick out. This protruding portion of the thread is used after curing of the molding material to pull the entire insert out.

The filled mold is subjected to curing process that will lead to the molding material solidification. For purposes of this invention, curing is a process for converting the soft molding material into a more durable and rigid solid. For instance, curing could be achieved by subjecting raw elastomers to higher temperatures and reaction with different vulcanizing agents (i.e. sulfur or organic peroxides which generate active oxygen under thermal exposure). Such process is used for High Temperature Vulcanization (HTV) Silicone Rubbers. Room Temperature Vulcanization (RTV) Silicone Rubbers could be vulcanized at lower temperatures via the chemical reaction utilizing chemical curing additives. RTV and HTV processes could be combined. Chemical additives modify the polymer by forming cross-links (bridges) between individual polymer chains. High temperatures initiate similar polymer bridging inner reactions because of active oxygen contained in small quantities in elastomers. Resulting vulcanized materials are rubber-like, non-sticky and more rigid, having superior mechanical properties.

Upon vulcanization, the introduced tightly packed cylindrical line expands and hardens, filling the inner volume and accepting the shape of the mold. Unlike usual molding process, the mass of a solidified rubber or polymer obtained through the proposed method keeps the separable, divisible structure of the continuous thread, while being constrained by bending forces to return to the solid shape of the insert. Such configuration is achievable due to the presence of the inert coating fluid, that does not allow lines to mold together to form a solid mass. Preservation of the continuous thread allows the entire insert to be removed through the opening by pulling on the thread's end that was left hanging outside of the insert entry. Due to the hardening after the curing, the entire structure is easily self-assembled back into the shape of the mold, once it is pulled out. As such, the insert could be used for the molding of the hollow object during the next step of the casting process.

The insert could be reused as many times as molding material could withstand without breaking or tearing. With the vulcanized rubber, the repeated removal and re-insertion was achieved at least one hundred times. The range of the working cycle of the insert could be improved from hundreds to thousands. In general, durability of the insert depends on the diameter of the extruded cylinder of the raw material, the complexity of the inner shape of the mold, hollow area entrance diameter, type of elastomer used for the mold, and curing conditions. The multiple reuse of the insert allows for continuous flow of the repeating molding process and easier use in the mass molding production.

Another advantage of the proposed method is the absence of the tearing points on the continuous lines forming the insert. In the previously used molding procedures, some of the intricate moldings are removed from the mold cavity by careful spiral cutting of the molding material from the cavity into the extractable narrower form, pulling the extractable form through the narrow insert opening, followed by the reassembly of the cut-out extractable form into the shape of the insert. The cut-out inserts produced by this method of removal are usually weakened by numerous tearing points produced by sharp instrument during the cutting. Abundance of tearing points prevents the repeated reuse of the cutout insert and is usually restricted to couple more slow and painstaking applications due to the inevitable breaking and tearing of the material. The continuous line of solidified molding material produced by the proposed method would withstand repeated pressure applications as no tearing points are generated.

The present invention should not be restricted to the molding of the intricate or hollow jewelry. It could be used for any other molding processes, when the removal of the large object through a narrow cavity is desired.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a prospective view of a complex molding form being injected through an opening cavity with a raw molding material by means of syringe;

FIG. 2 is a prospective view of a molding form completely filled with the raw molding material coated with coating fluid and cut from the syringe;

FIG. 3 is a schematic representation of a curing step when the molding form filled with the raw molding material coated with fluid undergoes curing;

FIG. 4 is a view of a step of a cured molding material removal through the opening cavity in the molding form;

FIG. 5 is a prospective view of the cured molding material removed from the molding form in an unwrapped configuration.

FIG. 6 is a prospective view of a step when the cured molding material wraps back together to restore itself into the shape of the insert mold.

### DETAILED DESCRIPTION OF PREFERRED EMBODIMENTS

For the purposes of promoting and understanding the principles of the invention, reference will now be made to one or more illustrative embodiments illustrated in the drawings and specific language will be used to describe the same.

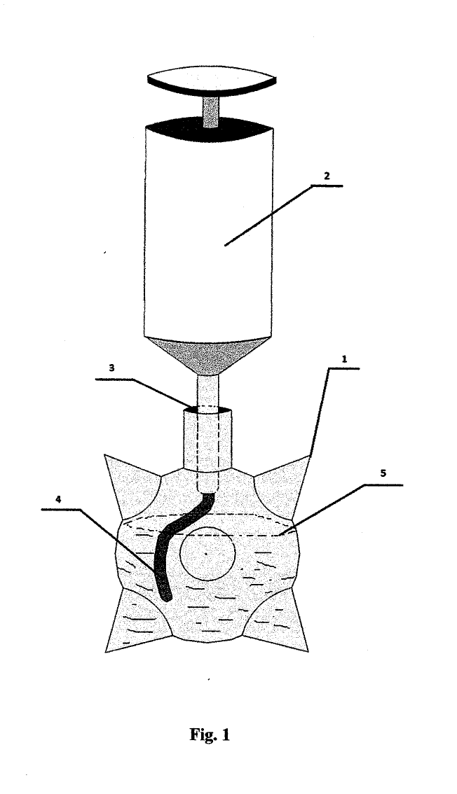

Referring to FIG. 1, a step of filling the mold form 1 with a raw molding material 4 via syringe 2 is depicted. The open end of the syringe is inserted into the opening of the cavity 3 in the molding form. The inside of the cavity of the molding form 1 is hollow and in the depicted embodiment is filled with a coating fluid 5 completely or partially prior to being filled with the raw molding material. As the syringe is squeezed, the narrow thread of the raw molding material 4 is being protruded inside the mold form. As the molding material fills the mold form, it is evenly coated with the coating fluid, replacing the coating fluid inside the mold form.

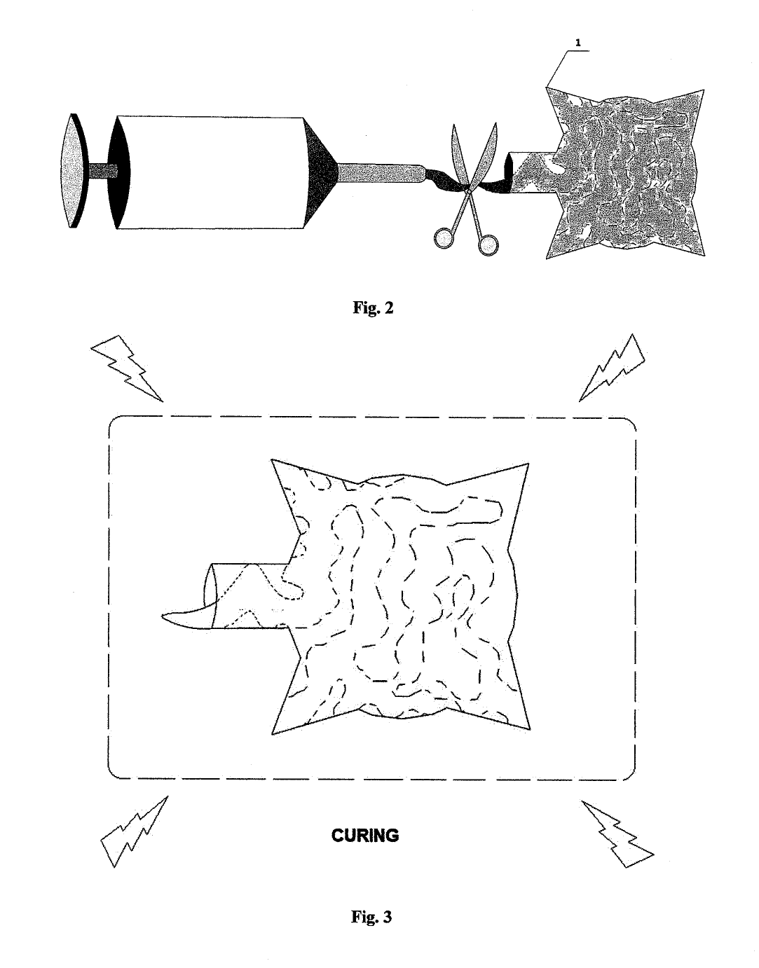

As could be seen from FIG. 2, as soon as the mold form is completely filled with the raw molding material coated with the coating fluid, the thread is cut off from the syringe. At this point, the coated raw molding material is tightly packed inside the mold form 1, with the cut-off end protruding from the opening of the cavity entrance.

FIG. 3 provides a schematic view of the curing step. During the curing step, the entire mold form with the coated raw molding material inside is subjected to chemical, thermal, electrical, ultraviolet or any other vulcanization treatment. During this step, the raw molding material undergoes chemical changes, forming internal bonds between the polymer links, turning into a more solid and rigid form. Due to the even coating with the coating fluid, there is no bonding between the threads of the molding material. To reduce the likelihood of such bonding, the coating fluid is usually selected from chemically inert liquids like mineral oils, organic oils, or combination of such oils with different powder fillers.

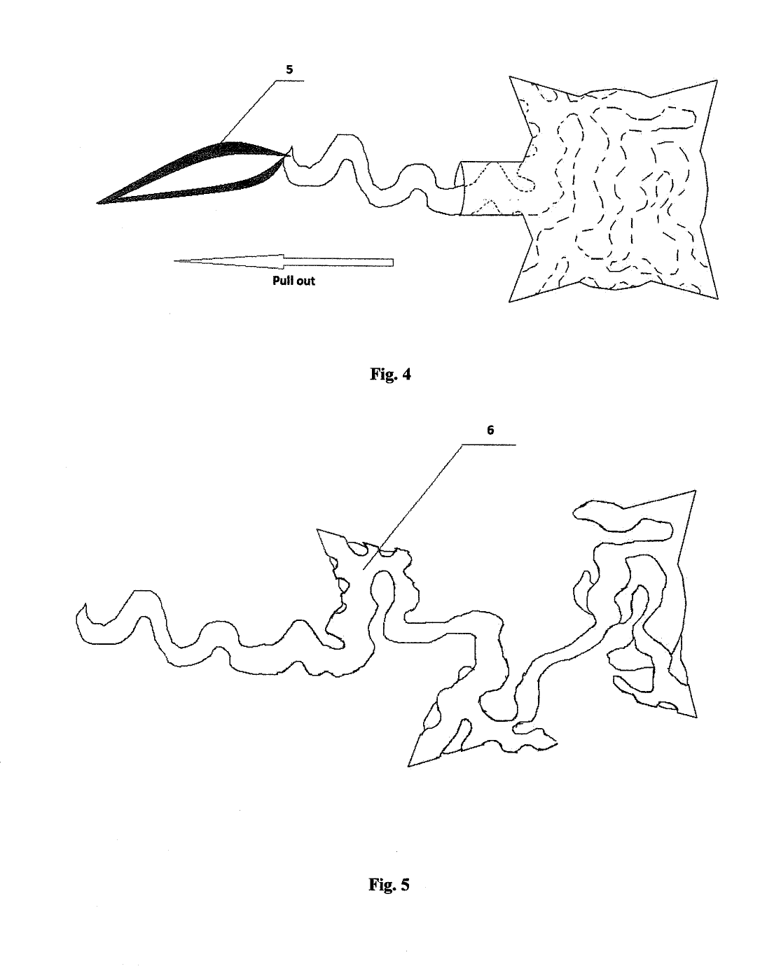

FIG. 4 demonstrates removal of the cured molding material from the cavity opening by means of tweezers. During this step, the entire uninterrupted line of the rigid vulcanized material is pulled through the narrow cavity opening layer by layer, in order to free the mold form. This process is a reverse of steps described in FIG. 1 and FIG. 2. The cured molding material is more rigid than previously injected soft raw molding material, allowing for the removal of the entire thread without tearing. Similar to a squeezed memory foam, the removed cured molding material strives to return to the shape of the mold form as soon as it is completely removed from the mold form.

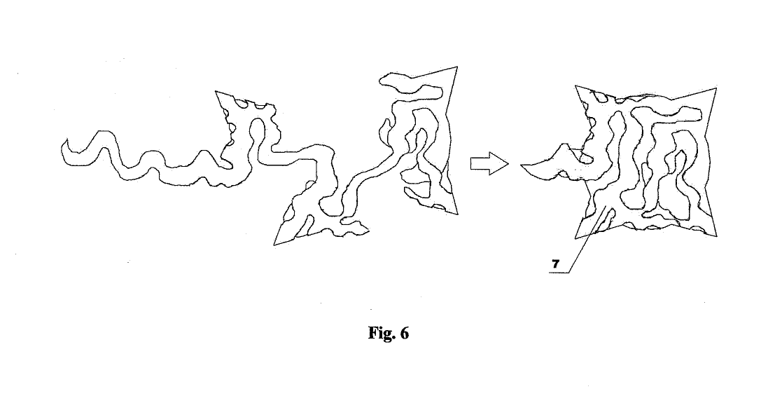

FIG. 5 depicts the unwrapped form of the vulcanized molding material after being pulled from the mold form. This configuration of the cured molding material is strained due to the deformation after being pulled from the mold form. Due to rigidity, the cured molding material strives to resume the shape of the mold form.

FIG. 6 depicts the process of the cured molding material assuming the shape of the mold form or the insert. The thread, reassembled in the shape of the mold form, is ready to be used in the next step of the molding process. Due to the improved rigidity and resistance of the cured molding material, the next step of molding could be repeated many times before wear-and-tear causes the breaking of the insert.

Figures provide preferred embodiment of the invention. However, the invention is not limited to the disclosed configuration. Number of different materials could be used in place of the raw molding material and in place of the coating liquid. The mold form could be of any configuration, and could be filled from many different openings.

While the invention has been illustrated and described in detail in the foregoing drawings and description, the same is to be considered as illustrative and not restrictive in character, it being understood that only illustrative embodiments thereof have been shown and described and that all changes and modifications that come within the sprit and scope of the invention as defined in the following claims are desired to be protected.

1. An unmixable combination comprising:
an elastomer having a property to change into a more rigid physical state under an outside influence;
a fluid, having a property to remain unchanged under said outside influence;
said elastomer further having a property to be protruded to enter a hollow cavity, while said fluid spreads on the said elastomer's surface, preventing said elastomer from binding with itself and other surfaces;
said unmixable combination being used to fill said hollow cavity and further used in a molding process.

2. The unmixable combination of claim 1, wherein said elastomer is selected from the group consisting of high temperature vulcanizing silicone (HTV), mold making rubber, natural rubber, room temperature vulcanization (RTV) silicone putty, thermoplastic rubbers (also known as thermoplastic elastomers, or TPE), and reactoplastic polymers.

3. The unmixable combination of claim 1, wherein said fluid is selected from the group consisting of mineral oil, organic oil, siloxanes, and Mold Release liquids.

4. The unmixable combination of claim 1, wherein fluid is further mixed with filler powder selected from the group consisting of metal powders, metal oxide powders, silicate powders, calcium carbonate powders, granite powders, synthetic filler powders and sand powders.

5. The unmixable combination of claim 1, wherein said fluid is placed inside said hollow cavity, prior to the elastomer being protruded into the hollow cavity, to assure the coating of the elastomer by the fluid.

6. The unmixable combination of claim 1, wherein said elastomer is protruded in said hollow cavity in a shape of a thread.

7. The unmixable combination of claim 1, where said elastomer and said fluid are combined prior to filling said hollow cavity.

8. The unmixable combination of claim 1, wherein said outside influence is selected from the group consisting of ultraviolet, ultrasound, chemical, electrical and thermal treatment.

9. The unmixable combination of claim 1, wherein said elastomer is stored in a container and protruded out through an opening in the container, by applying pressure to said container, said container opening's shape and diameter determining the shape and diameter of said thread.

10. The unmixable combination of claim 1, wherein said hollow cavity has multiple openings that could be filled with said unmixable combination to assure a complete filling of said hollow cavity.

11. A method of molding complex objects, said method comprising the steps of:
(a) providing a hollow cavity with single or multiple openings;
(b) protruding an elastomer under pressure from a container through an opening inside said hollow cavity in shape of a thread to fill up said hollow cavity, while said elastomer thread is being coated with a fluid;
(c) cutting the elastomer thread coated with the fluid after the hollow cavity is completely filled with the elastomer coated with the fluid, allowing the end of the thread to protrude from the hollow cavity's opening;
(d) subjecting the hollow cavity filled up with the unmixable combination of the elastomer and the fluid to an outside influence to change the elastomer to a more rigid physical state;
(e) removing a more rigid solid material thread from the hollow cavity by pulling the protruding narrow continuous thread out of the hollow cavity;
(f) reassembling the pulled-out rigid solid material thread into a shape of the hollow form for the continuous use in a repeated molding.

12. A method of claim 11, wherein said method is used for a molding process selected from a group consisting of jewelry molding, dental implants molding, hearing aids molding, high-precision industrial molding.
